(19) United States
(12) Patent Application Publication
(10) Pub. No.: US 2024/0140765 A1
(43) Pub. Date: May 2, 2024

(54) Overhead hoist transfer

(71) Applicants: Jung-Chieh Chang, Miaoli (TW); Yi-Sheng Chen, Miaoli (TW); Jen-Yung Hsiao, Miaoli (TW); Chia-Fu Hsiao, Miaoli (TW); Wei-Qi Lao, Miaoli (TW); Chen-Chih Chan, Miaoli (TW); Caung-Yu Liu, Miaoli (TW)

(72) Inventors: Jung-Chieh Chang, Miaoli (TW); Yi-Sheng Chen, Miaoli (TW); Jen-Yung Hsiao, Miaoli (TW); Chia-Fu Hsiao, Miaoli (TW); Wei-Qi Lao, Miaoli (TW); Chen-Chih Chan, Miaoli (TW); Caung-Yu Liu, Miaoli (TW)

(21) Appl. No.: 18/373,305

(22) Filed: Sep. 27, 2023

(30) Foreign Application Priority Data
Nov. 1, 2022 (TW) 111211925

(51) Int. Cl. B66C 19/00; B66C 9/02; B66C 9/04

(52) U.S. Cl. CPC B66C 19/00; B66C 9/02; B66C 9/04

(57) ABSTRACT

An overhead hoist transfer apparatus includes a rail assembly including a straight rail having an empty section, and a curved rail having a curved empty section; an engine including a first LSD having first and second wheels at two sides respectively; and a second LSD having third and fourth wheels at two sides respectively; a moving carriage driven by the engine and suspended from the rail assembly; first and second guide wheels disposed on the first LSD; third and fourth guide wheels disposed on the second LSD; and two guide boards disposed above a joining point of the straight rail and the curved rail. An elevation of the guide boards is equal to that of the guide wheels. The guide board includes a straight edge and a curved edge.

### BACKGROUND OF THE INVENTION

### 1. Field of the Invention

The invention relates to overhead hoist transfers (OHTs) and more particularly to such a overhead hoist transfer having limited slip differentials (LSDs) for allowing the wheels at two opposing sides to rotate at different speeds while cornering.

### 2. Description of Related Art

A conventional OHT is shown in FIG. 10 and comprises a rail assembly 70 including a main rail 71 and a first rail 711 connected to a curved path P1 which is in turn connected to the main rail 71; and a carriage assembly 60 movably disposed on the rail assembly 70 and including an engine 61 having three wheels 612 at either side and a drive mechanism 614 interconnecting the wheels 612 of the two sides and having two electric motors 6141 and a differential (not shown); and a moving carriage 62 driven by the engine 61 and suspended from the rail assembly 70. The wheels 612 at two opposing sides driven by the drive mechanism 614 rotate at different speeds when the carriage assembly 60 moves from the main rail 71 to the first rail 711 via the curved path P1 (i.e., cornering). The rail assembly 70 further comprises a second rail 73, a first substitute rail 74 mounted on the first rail 711 and moveably disposed on a first empty section 712 and the curved path P1, and a second substitute rail 76. The conventional OHT further comprises a first switch 75 for switching the first substitute rail 74 to a first initial position or a straight position. The first substitute rail 76 is partially disposed on a straight path P2 and across the main rail 71 and the second rail 73.

The drawback of the conventional OHT is that it may not move normally when it passes an empty portion of the rails because the differential does not have the function of keeping balanced movement of the OHT when encounters the condition.

Thus, the need for improvement still exists.

### SUMMARY OF THE INVENTION

It is therefore one object of the invention to provide a overhead hoist transfer comprising a rail assembly including a straight rail having an empty section, and a curved rail having a curved empty section; an engine including a first LSD having a first wheel and a second wheel at two sides respectively; and a second LSD having a third wheel and a fourth wheel at two sides respectively; and a moving carriage driven by the engine and suspended from the rail assembly; first and second guide wheels disposed on the first LSD; third and fourth guide wheels disposed on the second LSD; and two guide boards disposed above a joining point of the straight rail and the curved rail, an elevation of the guide boards being equal to that of the guide wheels, and each of the guide boards including a straight edge and a curved edge.

The above and other objects, features and advantages of the invention will become apparent from the following detailed description taken with the accompanying drawings.

### BRIEF DESCRIPTION OF THE DRAWINGS

FIG. 1 is a top plan view of an overhead hoist transfer (OHT) according to the invention;

FIG. 2 is a perspective view of the OHT;

FIG. 3 is a front elevation view of the OHT;

FIG. 4 is a top plan view of a portion of the OHT showing the moving carriage passing a curved path of the rail;

FIG. 5 is a top plan view of a portion of the OHT showing the moving carriage passing a straight path of the rail;

FIG. 6 is a top plan view of a portion of the OHT showing the moving carriage passing the straight path of the rail guided by the guide board;

FIG. 7 is a top plan view of a portion of the OHT showing the moving carriage passing the curved path of the rail guided by the guide board;

FIG. 8 is a continuation of FIG. 6 showing the moving carriage passing the straight path of the rail further guided by the guide board;

FIG. 9 is a continuation of FIG. 7 showing the moving carriage passing the curved path of the rail further guided by the guide board; and

FIG. 10 is a top plan view of a conventional OHT.

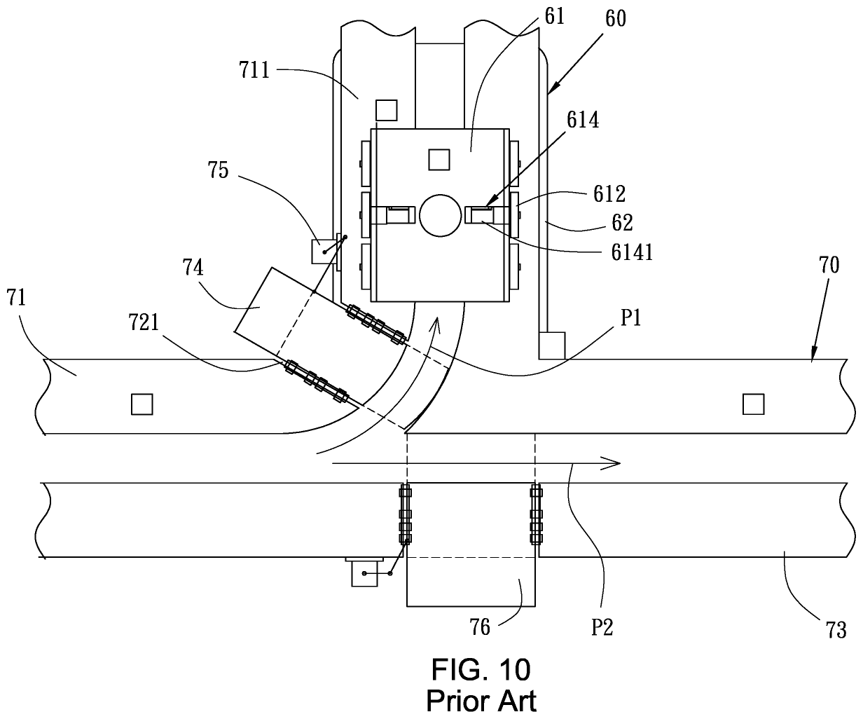

### DETAILED DESCRIPTION OF THE INVENTION

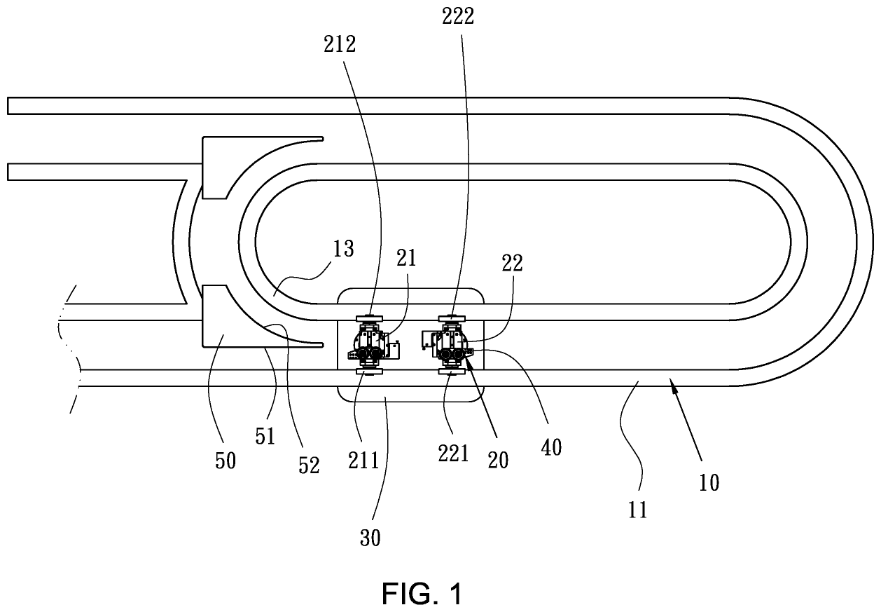

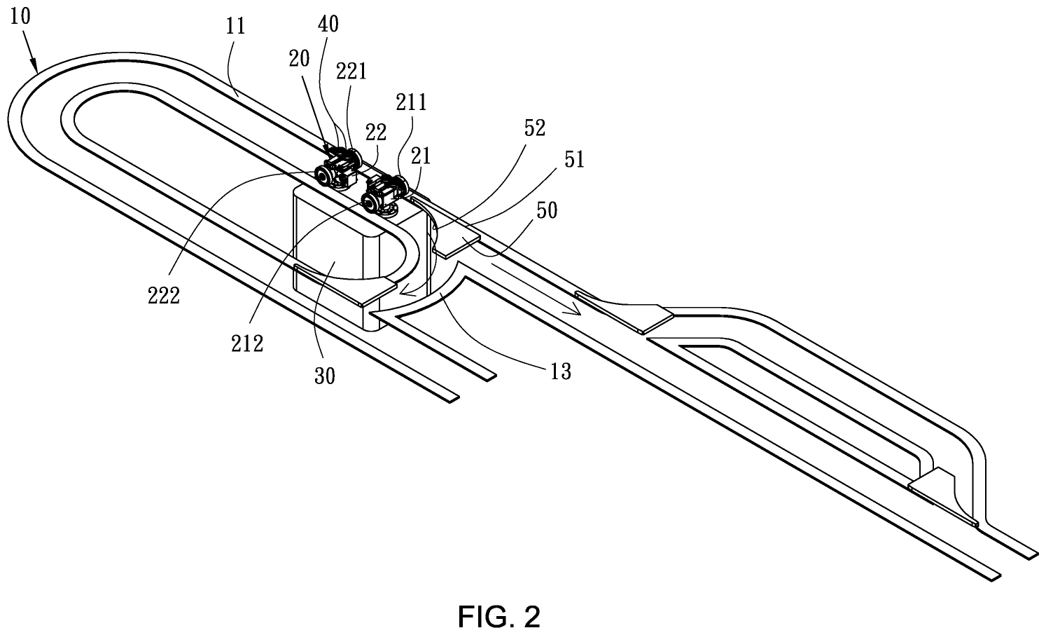

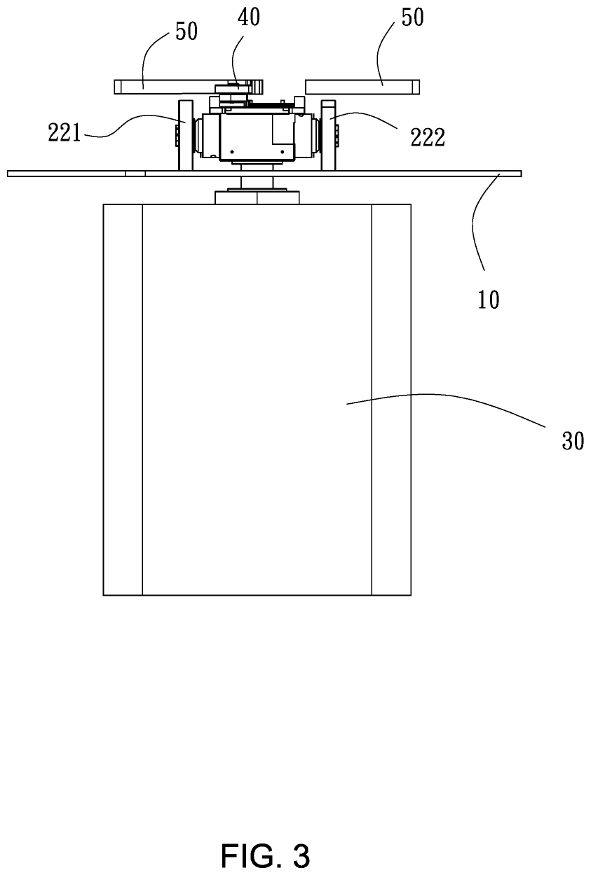

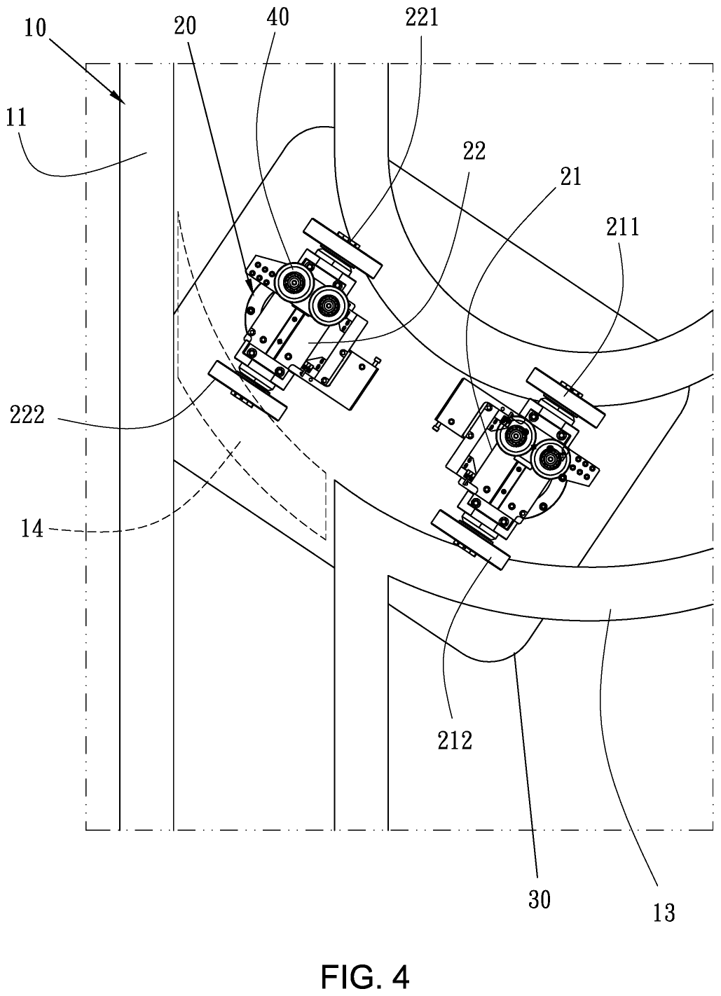

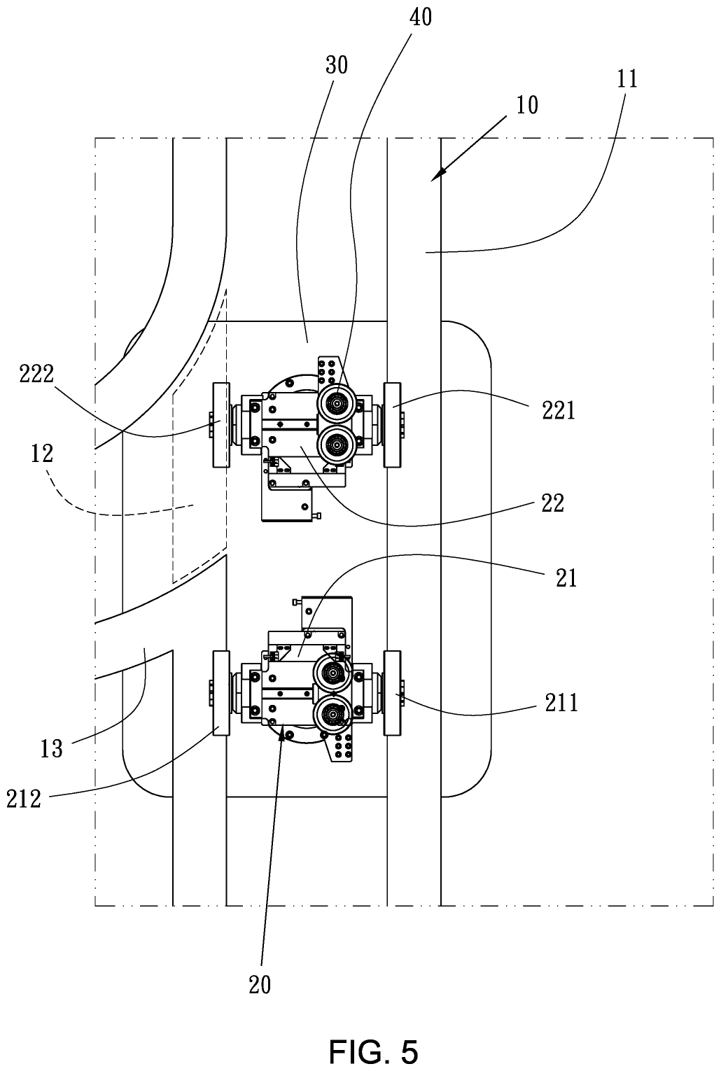

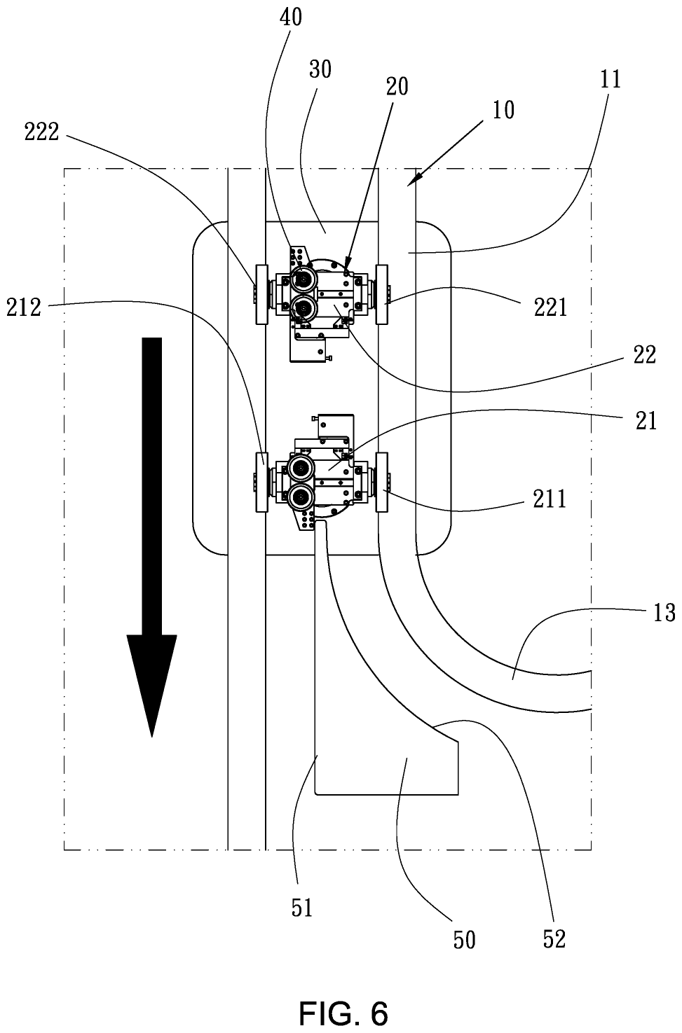

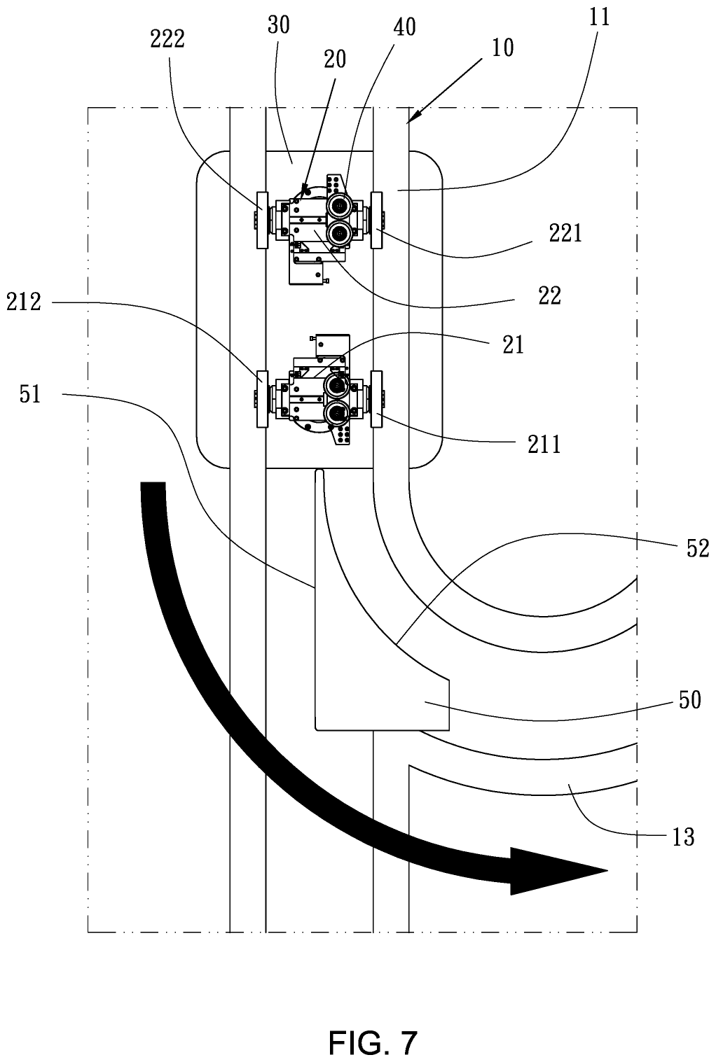

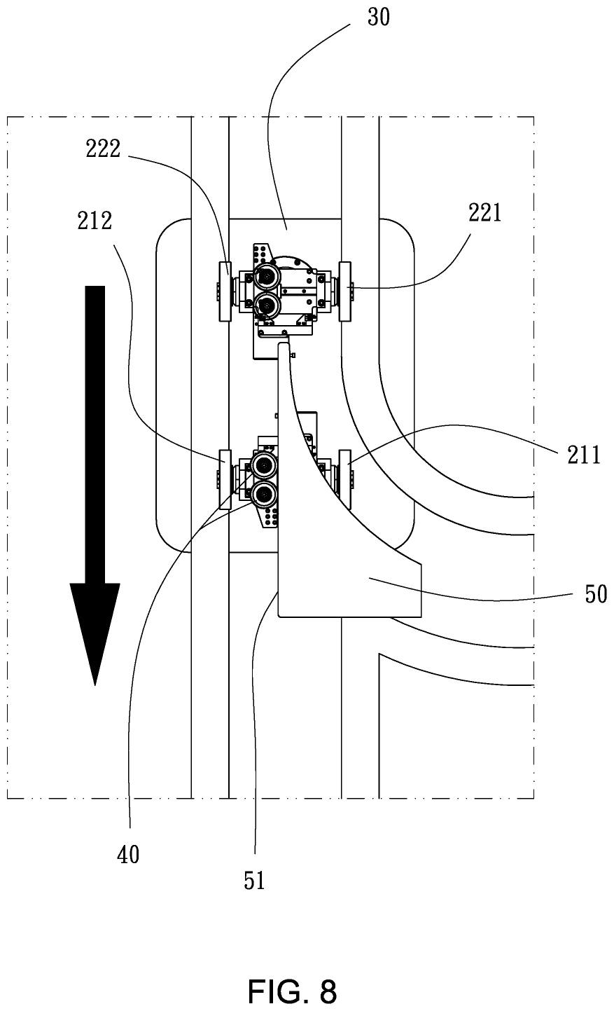

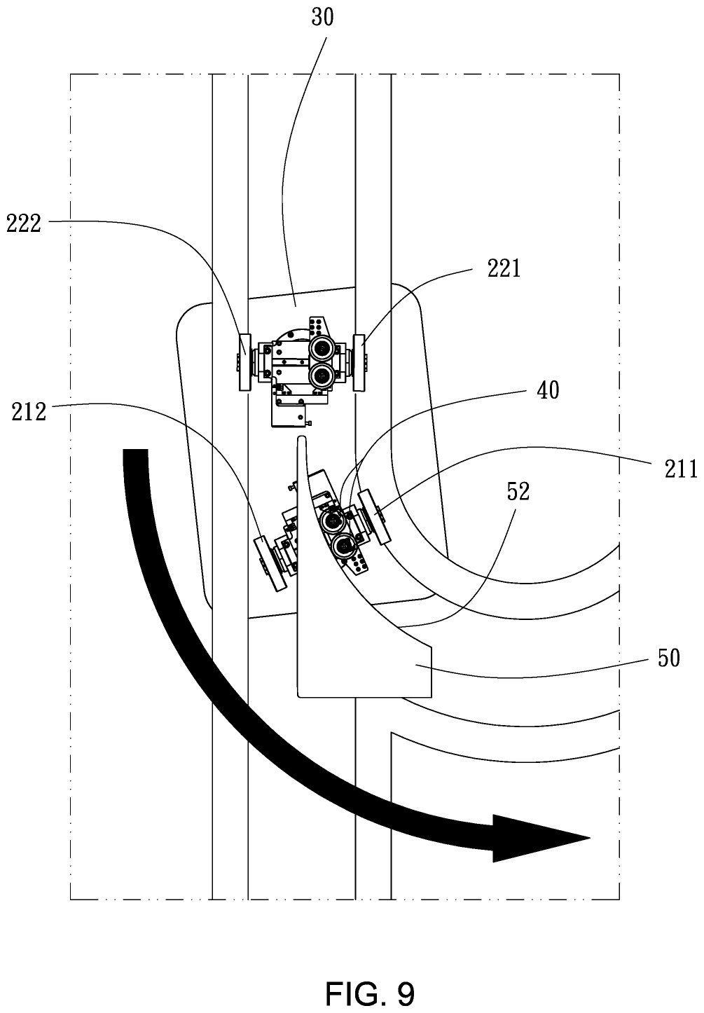

Referring to FIGS. 1 to 9, an overhead hoist transfer (OHT) in accordance with the invention comprises a rail assembly 10 including a straight rail 11 and a curved rail 13; an engine 20 including a first LSD 21 having a first wheel 211 and a second wheel 212 at two sides respectively; a second LSD 22 having a third wheel 221 and a fourth wheel 222 at two sides respectively; and a moving carriage 30 driven by the engine 20 and suspended from the rail assembly 10.

When the engine 20 passes through an empty section 12 of the straight rail 11 (or an empty section 14 of the curved rail 13), only one of the first, second, third and fourth wheels 211, 212, 221 and 222 is suspended and the remaining three wheels rotate normally.

When the first, second, third and fourth wheels 211, 212, 221 and 222 pass through the curved rail 13, the first LSD 211 and the second LSD 22 may adjust rotational speed of the first, second, third and fourth wheels 211, 212, 221 and 222 automatically.

The OHT further comprises four guide wheels 40 in which two guide wheels 40 are provided on the first LSD 21 and the other two guide wheels 40 are provided on the second LSD 22. the four guide wheels 40 may simultaneously rotate when the engine 20 moves.

The OHT further comprises two guide boards 50 disposed above a joining point of the straight rail 11 and the curved rail 13. the guide boards 50 are at the same elevation as the guide wheels 40. the guide board 50 includes a straight edge 51 and a curved edge 52.

When the engine 20 moves, the guide wheels 40 may move along the straight edge 51 or the curved edge 52 to guide the first, second, third and fourth wheels 211, 212, 221 and 222 to pass through the curved edge 52 and the curved rail 13.

While the invention has been described in terms of preferred embodiments, those skilled in the art will recognize that the invention can be practiced with modifications within the spirit and scope of the appended claims.

What is claimed is:

1. An overhead hoist transfer, comprising:
a rail assembly including a straight rail having an empty section, and a curved rail having a curved empty section;
an engine including a first LSD having a first wheel and a second wheel at two sides respectively; and a second LSD having a third wheel and a fourth wheel at two sides respectively;
a moving carriage driven by the engine and suspended from the rail assembly;
first and second guide wheels disposed on the first LSD;
third and fourth guide wheels disposed on the second LSD; and
two guide boards disposed above a joining point of the straight rail and the curved rail, an elevation of the guide boards being equal to that of the guide wheels, and each of the guide boards including a straight edge and a curved edge.
